(19) United States
(12) Patent Application Publication
(10) Pub. No.: US 2014/0173649 A1
(43) Pub. Date: Jun. 19, 2014

(54) Fast Service Change

(71) Applicants: Arun Kumar Medapati, Andhra Pradesh (IN); Amit Chhabra, Bangalore (IN); Srinivas Chandupatla, Andhra Pradesh (IN)

(72) Inventors: Arun Kumar Medapati, Andhra Pradesh (IN); Amit Chhabra, Bangalore (IN); Srinivas Chandupatla, Andhra Pradesh (IN)

(73) Assignee: Cisco Technology Inc., San Jose, CA (US)

(21) Appl. No.: 14/126,739

(22) PCT Filed: Jun. 19, 2012
(86) PCT No.: PCT/IB2012/053084

§ 371 Date: Jan. 14, 2014

(30) Foreign Application Priority Data
Jun. 22, 2011 (IN) 1772/DEL/2011
Aug. 18, 2011 (GB) 1114221.3

(51) Int. Cl. H04N 21/254

(52) U.S. Cl. CPC H04N 21/2541
USPC 725/25

(57) ABSTRACT

A method and apparatus is described to achieve a fast service change. The method includes: receiving a plurality of transport streams at a client device, each transport stream including a plurality of encrypted services; decrypting an encrypted service from the plurality of encrypted services thereby forming a decrypted service; playing out the decrypted service; storing a portion of at least one encrypted service from the plurality of encrypted services in a storage device; receiving a request for displaying a different encrypted service; identifying a stored portion of the different encrypted service; decrypting the stored portion of the different encrypted service thereby forming a decrypted stored portion; playing out the decrypted stored portion of the different encrypted service at a faster than real time speed; storing a subsequent portion of the different encrypted service in the storage device, the subsequent portion corresponding to a subsequent portion of the different encrypted service received during the decrypting of the stored portion and the playing out the decrypted stored portion of the different encrypted service; decrypting the subsequent stored portion of the different encrypted service thereby forming a decrypted subsequent portion; and playing out the decrypted subsequent portion of the different encrypted service for display upon completion of the playing out of the decrypted stored portion.

### FIELD OF THE INVENTION

The present invention relates to methods and apparatus for achieving a fast service change.

### BACKGROUND OF THE INVENTION

The meanings of certain acronyms and abbreviations used herein are given in Table 1.

TABLE 1
Acronyms and Abbreviations

| | |
|---|---|
| AV | Audio Video |
| CA | Conditional Access |
| DVR | Digital Video Recorder |
| ECM | Entitlement Control Message |
| EIT pf | Event Information Table present following |
| EIT sch | Event Information Table schedule |
| ES | Elementary Stream |
| GOP | Group Of Pictures |
| IP | Internet Protocol |
| IR | InfraRed |
| MPEG | Motion Picture Experts Group |
| MPEG-2 | Motion Picture Experts Group 2 |
| PAT | Program Association Table |
| PID | Packet Identifier |
| PMT | Program Map Table |
| PSI | Program Specific Information |
| STC | System Time Clock |
| TS | Transport Stream |

The following definitions (taken from Digital Video Broadcasting (DV); Specification for Service Information (SI) in DVB systems, ETSI EN 300 468 V 1.8.1) will aid understanding of the embodiments of the present invention.

Event: grouping of elementary broadcast data streams with a defined start and end time belonging to a common service;

Conditional Access (CA) system: system to control subscriber access to services, programmes and events;

Network: collection of MPEG-2 Transport Stream (TS) multiplexes transmitted on a single delivery system;

Programme: concatenation of one or more events under the control of a broadcaster e.g. news show, entertainment show;

Service: sequence of programmes under the control of a broadcaster which can be broadcast as part of a schedule;

Service Information (SI): digital data describing the delivery system, content and scheduling/timing of broadcast data streams, etc. It includes MPEG-2 PSI together with independently defined extensions;

Program Association Table (PAT): for each service in the multiplex, the PAT indicates the location of the corresponding Program Map Table (PMT). It also gives the location of the Network Information Table (NIT);

Program Map Table (PMT): the PMT identifies and indicates the locations of the streams that make up each service and the location of the Program Clock Reference fields for a service;

Motion Pictures Experts Group 2 (MPEG-2): a standard for the generic coding of moving pictures and associated audio information as described in ISO/IEC 13818;

Transport Stream (TS): a communications protocol for audio, video, and data which is specified in MPEG-2 Part 1, Systems (ISO/IEC standard 13818-1);

Elementary Stream (ES): stream of raw transport packets (such as audio, video and data) within a transport stream sharing a common Packet IDentifier (PID).

The term “service” is intended to include the MPEG concept of a “program”. A “service” can also be referred to as “channel” in other contexts.

As digital television transmission has replaced analog broadcasts, viewers have found the advantages of the newer mode are offset by a relatively long latency period when changing services, as compared to the nearly instant response of a traditional analog tuner. There are several reasons for this difference in service change between analog and digital television. Generally, this difference may be due to several cumulative time factors, for example, tuning time, data acquiring time, decrypting time and Motion Pictures Expert Group (MPEG) sequencing time.

The tuning time is the time it takes to switch between different tuners and/or different carrier frequencies if the different service that is to be displayed is on another Transport Stream (TS). The data acquiring time is the time it takes to acquire Service Information (SI) data (e.g. Program Map Table (PMT)) in order to locate the different service within the tuned TS. The decrypting time represents the time it takes to acquire Entitlement Control Messages (ECMs) associated with the encrypted service that is to be displayed and to send it to a Control Word (CW) manager, the CW manager using the ECMs to derive a control word for use in decrypting the encrypted service. Finally, the MPEG sequencing time is the time it takes to acquire the most recent I-frame. The MPEG sequencing time also includes the time it takes to decode and present audio and video in synchronization.

A video sequence known as “group of pictures” (GOP) comprises a plurality of video frames. The GOP begins with an intra-coded frame or I-frame, which is an independently decodable frame. The I-frame is followed by zero or more “predicted frames” known as predicted frames (P-frames) and bidirectional frames (B-frames), which are encoded relative to the I-frame and/or one another, and generally cannot be decoded unless an I-frame is available. In other words, the GOP is decodable once the I-frame has become available to the decoder.

A request to display a different service received from a user may occur randomly in the course of an MPEG-2 stream. Therefore, it is generally unaligned with the current I-frame. Hence, decoding of the different service is delayed until arrival of a new I-frame. The delay in video presentation may increase due to inherent latencies within the decoder (i.e. buffering delays involved in decoding and presenting video and audio in synchronization. Section 2.4.2.4 (Decoding) of ISO/IEC 13818.1-1:2000 Information technology—Generic coding of moving pictures and associated audio information: Systems explains the buffering delay in greater detail). In some cases, this delay may be as much as the GOP duration plus the synchronization time.

Those skilled in the art will appreciate that the time it takes to achieve a service change may be different whether the service that is to be displayed is encrypted or not.

For encrypted services, the service change time (referred as Tsc below) is given by:

Tsc=Tuning time+Acquiring time+Decrypting time+MPEG Sequencing time

Those skilled in the art will appreciate that the decrypting time and the MPEG sequencing time are given by:

Decryptingtime=ECMAcquiringtime+CWGeneratingtime; and MPEG Sequencing time=I frame time+Sync.time

For non-encrypted services, the service change time is given by:

Tsc=Tuning time+Acquiring time+MPEG Sequencing time

An example of these times is shown in Table 2 below:

TABLE 2
Exemplary times in a service change

| | | Average |
|---|---|---|
| Task | Sub-task | time (s) |
| Tuning time (if service is on another TS) | | 0.05 |
| Acquiring SI tables | PAT | 0.10 |
| | PMT | 0.10 |
| | | 0.20 |
| Decrypting | Acquiring ECM | 0.10 |
| | Generating CW | 0.30 |
| | | 0.40 |
| MPEG | Waiting for I-frame | 0.5 |
| | Synchronizing | 0.25 |
| | | 0.75 |

The accumulation of all these times leads to an overall time of at least approximately 1 second for non-encrypted services, and often of at least approximately 1.4 seconds for encrypted services.

PCT Published Patent Application WO2006/044547 of OpenTV Inc. describes a method and an apparatus to reduce delay when changing channels in a television environment. The method may comprise receiving a plurality of television channels from a remote content provider wherein each channel includes channel information required to display the channel. At least one channel of the plurality of channels may be identified as a stored channel and channel information of the at least one stored channel may be stored in storage (e.g. in a circular buffer). Thereafter, upon selection of the stored channel, the stored channel information is accessed for display. In an example embodiment, the storage may be updated to maintain a most recently received I-frame and subsequent MPEG signals of the stored channel. Accordingly, when changing channels it may not be necessary to wait for the next I-frame to display a newly selected channel.

PCT Published Patent Application WO2010/015882 of NDS Ltd et al. describes a method and a system for tuning a set top box to a carrier frequency, the carrier frequency carrying a transport stream, acquiring a subset of transport stream associated metadata, the subset of transport stream associated metadata including a plurality of pointers to a plurality of elementary streams, the plurality of elementary streams including data and metadata associated with a desired content item, acquiring the plurality of elementary streams indicated in the subset of transport stream associated metadata, the plurality of elementary streams including at least a first stream including encrypted video frames, the encrypted video frames including at least one frame which includes an encrypted access point, and a second stream including an entitlement control word (ECM) stream, caching the encrypted video frames acquired from the first stream, acquiring an ECM from the second stream, the acquired ECM being associated with the cached acquired encrypted video frames, deriving a control word (CW) from the acquired ECM, decrypting the cached acquired encrypted video frames according to the CW, locating the at least one decrypted access point in the first stream, decrypting encrypted video frames included in the cached first stream, decoding the decrypted video frames from the at least one decrypted access point, and displaying the decoded decrypted video frames included in the first stream, beginning at the located at least one decrypted access point, wherein the decrypting, decoding and displaying is performed at better than real-time. Related systems and methods are also described.

### SUMMARY OF THE INVENTION

There is thus provided in accordance with an embodiment of the present invention a method for achieving a fast service change, the method including: receiving a plurality of transport streams at a client device, each transport stream including a plurality of encrypted services; decrypting an encrypted service from the plurality of encrypted services thereby forming a decrypted service; playing out the decrypted service; storing a portion of, at least, one encrypted service from the plurality of encrypted services in a storage device; receiving a request for displaying a different encrypted service; identifying a stored portion of the different encrypted service; decrypting the stored portion of the different encrypted service thereby forming a decrypted stored portion; playing out the decrypted stored portion of the different encrypted service at a faster than real time speed; storing a subsequent portion of the different encrypted service in the storage device, the subsequent portion corresponding to a subsequent portion of the different service received during decrypting the stored portion and playing out the decrypted stored portion of the different encrypted service; decrypting the subsequent portion of the different encrypted service thereby forming a decrypted subsequent portion; and playing out the decrypted subsequent portion of the different encrypted service for display upon completion of the playing out of the decrypted stored portion.

Further, in accordance with an embodiment of the present invention, playing out the decrypted stored portion of the different encrypted service includes playing out the decrypted stored portion of the different encrypted service in System Time Clock fast forward speed.

Still further, in accordance with an embodiment of the present invention, the playing out the decrypted stored portion of the different encrypted service includes playing out the decrypted stored portion of the different encrypted service at a maximum faster than real time speed that the client device is able to handle.

Additionally, in accordance with an embodiment of the present invention, the playing out the decrypted stored portion of the different encrypted service includes playing out the decrypted stored portion of the different encrypted service at a non-constant speed.

Further, in accordance with an embodiment of the present invention, the playing out the decrypted subsequent portion commences with a P-frame.

Still further, in accordance with an embodiment of the present invention, the playing out the decrypted subsequent portion commences with a B-frame.

Additionally, in accordance with an embodiment of the present invention, the method further includes updating the storage device to store transport stream packets of, at least, one encrypted service most recently viewed.

Further, in accordance with an embodiment of the present invention, the portion of at least one encrypted service includes transport stream packets received during a time taken to receive a group of pictures.

Still further, in accordance with an embodiment of the present invention, the portion of at least one encrypted service further includes transport stream packets received during a time taken to achieve audio and video synchronization.

Additionally, in accordance with an embodiment of the present invention, the stored portion of at least one encrypted service further includes transport stream packets received during a time taken to receive less than a group of pictures.

Further, in accordance with an embodiment of the present invention, the stored portion includes an I-frame.

Still further, in accordance with an embodiment of the present invention, the stored portion does not include an I-frame.

Additionally, in accordance with an embodiment of the present invention, the method further includes selecting at one encrypted service from the plurality of services.

Further, in accordance with an embodiment of the present invention, the selecting at least one encrypted service from the plurality of encrypted services includes selecting at least one user favorite encrypted service.

Still further, in accordance with an embodiment of the present invention, the selecting at least one encrypted service from the plurality of encrypted services includes selecting encrypted services adjacent to the decrypted service.

Additionally, in accordance with an embodiment of the present invention, the selecting at least one encrypted service from the plurality of encrypted services includes selecting encrypted services most frequently watched.

Further, in accordance with an embodiment of the present invention, the selecting at least one encrypted service from the plurality of encrypted services includes selecting encrypted services most recently watched.

Still further, in accordance with an embodiment of the present invention, the selecting at least one encrypted service from the plurality of encrypted services includes selecting encrypted services most recently browsed in an electronic program guide.

Additionally, in accordance with an embodiment of the present invention, the selecting at least one encrypted service from the plurality of encrypted services includes selecting encrypted services listed by a television operator.

Further, in accordance with an embodiment of the present invention, the selecting at least one encrypted service from the plurality of encrypted services includes selecting encrypted services matching a user profile.

Still further, in accordance with an embodiment of the present invention, the selecting at least one encrypted service from the plurality of encrypted services includes selecting encrypted services most frequently recorded.

Additionally, in accordance with an embodiment of the present invention, the selecting at least one encrypted service from the plurality of encrypted services includes selecting at least one encrypted service broadcasting events tagged by the user.

Further, in accordance with an embodiment of the present invention, the selecting at least one encrypted service from the plurality of encrypted services includes selecting encrypted services broadcasting events most frequently tagged by the user.

Still further, in accordance with an embodiment of the present invention, the selecting at least one encrypted service from the plurality of encrypted services includes selecting encrypted services about to broadcast a tagged event.

Additionally, in accordance with an embodiment of the present invention, the selecting at least one encrypted service from the plurality of encrypted services includes selecting all encrypted services on at least one of the plurality of transport streams.

There is also provided in accordance with a further embodiment of the present invention a receiving device for achieving a fast service change, the receiving device including: means for receiving a plurality of transport streams, each transport stream including a plurality of encrypted services; means for decrypting an encrypted service from the plurality of encrypted services to form a decrypted service; means for playing out the decrypted service; means for storing a portion of at least one encrypted service from the plurality of encrypted services; means for receiving a request for displaying a different encrypted service; means for identifying a stored portion of the different encrypted service; wherein the means for decrypting is further for decrypting the stored portion of the different encrypted service to form a decrypted stored portion; and the means for playing out is further for playing out the decrypted stored portion of the different encrypted service at a faster than real time speed; and the means for storing is further for storing a subsequent portion of the different encrypted service, the subsequent portion corresponding to a subsequent portion of the different encrypted service received during the decrypting of the stored portion and the playing out of the decrypted portion of the different encrypted service; and the means for decrypting is further for decrypting the stored subsequent portion of the different encrypted service to form a decrypted subsequent portion; and the means for playing out is further playing out the decrypted stored subsequent portion of the different encrypted service for display upon completion of the playing out of the decrypted stored portion.

There is also provided in accordance with a further embodiment of the present invention a receiving device for achieving a fast service change, the receiving device including: at least one tuner operable to receive a plurality of transport stream, each transport stream including a plurality of encrypted services; a descrambler operable to decrypt an encrypted service from the plurality of encrypted services to form a decrypted service; a play out system operable to play out the decrypted service; a receiver operable to receive a request for displaying a different encrypted service; a storage device operable to store a portion of at least one encrypted service from the plurality of encrypted services; a demultiplexer operable to identify a stored portion of the different encrypted service; wherein the descrambler is further operable to decrypt the stored portion of the different encrypted service to form a decrypted stored portion; and the play out system is further operable to play out the decrypted stored portion of the different encrypted service at a faster than real time speed; and the storage device is further operable to store a subsequent of the different encrypted service, the subsequent portion corresponding to a subsequent portion of the different encrypted service received during the decrypting of the stored portion and the playing out of the decrypted portion of the different encrypted service; and the descrambler is further operable to decrypt the stored subsequent portion of the different encrypted service to form a decrypted subsequent portion; and the play out system is further operable to play out the decrypted stored subsequent portion of the different encrypted service for display upon completion of the playing out of the decrypted stored portion.

### BRIEF DESCRIPTION OF THE DRAWINGS

The present invention will be understood and appreciated more fully from the following detailed description, taken in conjunction with the drawings in which:

FIG. 1 is a simplified block diagram illustration of a system constructed and operative in accordance with an embodiment of the present invention;

FIGS. 2A and 2B are simplified block diagram illustrations of a demultiplexer constructed and operative in accordance with a further embodiment of the present invention;

FIGS. 3A-3D are simplified pictorial illustrations of a storage device constructed and operative in accordance with a further embodiment of the present invention;

FIG. 4 is a simplified block diagram illustration of a system constructed and operative in accordance with an embodiment of the present invention; and

FIG. 5 is a flow chart describing a method of operating a fast service change according to an embodiment of the present invention.

### DETAILED DESCRIPTION OF EMBODIMENTS

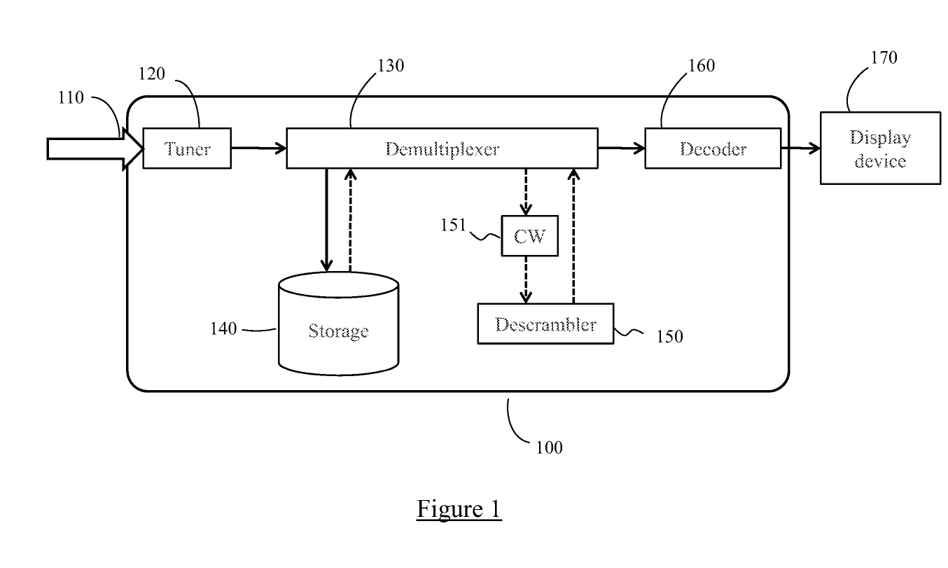

Reference is now made to FIG. 1, which is a simplified block diagram illustration of a system constructed and operative in accordance with an embodiment of the present invention.

A headend (not shown) typically communicates with a plurality of client devices via a communications network (not shown). Additionally or alternatively, a plurality of headends communicate with a single client device or with a plurality of client devices via the communications network. For simplicity of depiction and description, and without limiting the generality of the invention, only one client device 100 is illustrated in FIG. 1.

The communication network (not shown) is a one-way or two-way communication network that includes at least one of the following: a satellite based communication network; a cable based communication network; a conventional terrestrial broadcast television network; a telephony based communication network; a telephony based television broadcast network; a mobile-telephony based television broadcast network; an Internet Protocol (IP) television broadcast network; and a computer based communication network. It is appreciated that in alternative embodiments, the communication network may, for example, be implemented by a one-way or two-way hybrid communication network, such as a combination cable-telephone network, a combination satellite-telephone network, a combination satellite-computer based communication network, or by any other appropriate network. Other ways of implementing the communication network will be apparent to someone skilled in the art.

The system of FIG. 1 comprises a client device 100 disposed between a headend (not shown) and a display device 130. Client device 100 comprises a digital video recorder (DVR) that typically includes a high capacity storage device, such as a hard disk or high capacity memory. Client device is coupled to a display device 130. Client device 100 comprises a tuner 110, a demultiplexer 112, a decoder 113, a receiver (not shown) and a descrambler 117. It is appreciated that the client device 100 comprises standard hardware components and software components, as is well known in the art.

Client device 100 is typically connected in operation to display device 170 via a digital AV interface (e.g. HDMI, DVI, etc.) or via an analogue AV interface (e.g. component (RGB, YPbPr), composite (NTSC, PAL, SECAM), S-video, SCART, RF coaxial, D-Terminal (D-tanshi) etc.). While shown as separate entities in FIG. 1, the client device 100 may be integral with the display device 170 in other embodiments of the present invention.

Client device 100 typically receives, demultiplexes, decodes and decrypts/descrambles as necessary a broadcast television stream 120 received from a headend optionally under control of a conditional access device such as removable security element as is well known in the art. The removable security element typically includes a smart cart as is well known in the art. The output from client device 100 comprises a decoded and decrypted/descrambled as necessary audio video (AV) stream ready to be displayed on the display device 170.

The term “encoded” is used throughout the present specification and claims and claims, in all of its grammatical forms, to refer to any type of data stream encoding including, for example and without limiting the scope of the invention, well known techniques of encoding such as, but not limited to, MPEG-2 encoding, H.264 encoding, VC-1 encoding, and synthetic encodings such as Scalable Vector Graphics (SVG) and LASER (ISO/IEC 14496-20), and so forth. It is appreciated that an encoded data stream generally requires more processing and typically more time to read than a data stream which is not encoded. Any recipient of encoded data, whether or not the recipient of the encoded data is the intended recipient, is, at least in potential, able to read encoded data without requiring cryptanalysis. It is appreciated that encoding may be performed in several stages and may include a number of different processes, including, but not necessarily limited to: compressing the data; transforming the data into other forms; and making the data more robust (for instance replicating the data or using error correction mechanisms).

The term “compressed” is used throughout the present specification and claims, in all its grammatical forms, to refer to any type of data stream compression. Compression is typically a part of encoding and may include image compression and motion compensation. Typically, compression of data reduces the number of bits comprising the data. In that compression is a subset of encoding, the terms “encoded” and “compressed”, in all their grammatical forms, are often used interchangeably throughout the present specification and claims.

Similarly, the terms “decoded” and “decompressed” are used throughout the present specification and claims, in all their grammatical forms, to refer to the reverse of “encoded” and “compressed” in all their grammatical forms.

The terms “scrambled” and “encrypted”, in all of their grammatical forms, are used interchangeably throughout the present specification and claims to refer to any appropriate scrambling and/or encryption methods for scrambling and/or encrypting a data stream, and/or any other appropriate method for intending to make a data stream unintelligible except to an intended recipient(s) thereof. Well known types of scrambling or encrypting include, but are not limited to DES, 3DES, and AES. Similarly, the terms “descrambled” and “decrypted” are used throughout the present specification and claims, in all their grammatical forms, to refer to the reverse of “scrambled” and “encrypted” in all their grammatical forms.

Pursuant to the above definitions, the terms “encoded”; “compressed”; and the terms “scrambled” and “encrypted” are used to refer to different and exclusive types of processing. Thus, a particular data stream may be, for example:

encoded, but neither scrambled nor encrypted;

compressed, but neither scrambled or encrypted;

scrambled or encrypted, but not encoded;

scrambled or encrypted, but not compressed;

encoded, and scrambled or encrypted; or

compressed, and scrambled or encrypted.

Likewise, the terms “decoded” and “decompressed” on the one hand, and the terms “descrambled” and “decrypted” on the other hand, are used to refer to different and exclusive types of processing.

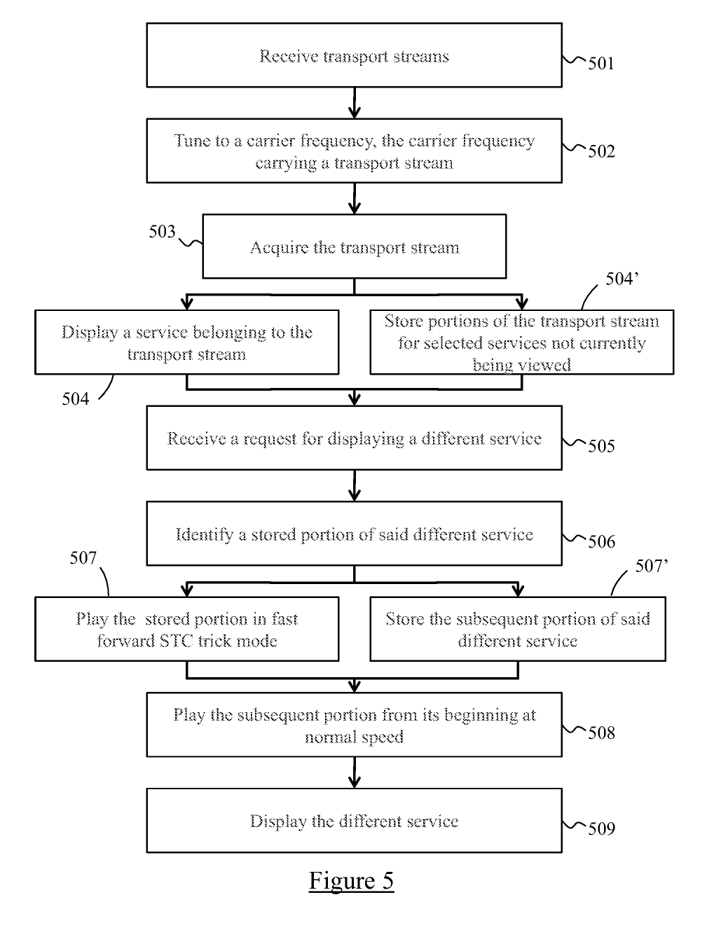

The operation of the system of FIG. 1 will be described in detail below in relation to the method of FIG. 5.

A headend (not shown) communicates a plurality of transport streams 110 to a client device 100 via a communication network (step 501). Client device 100 tunes to a carrier frequency, the carrier frequency transmitting a transport stream (step 502). The transport stream typically includes several transport stream packets. Each transport stream packet is identified by a Packet IDentifier value (PID). Several transport stream packets may be identified by the same PID. PIDs are typically used to identify services or programs transmitted as part of a DVB compliant transport stream. It is common to transmit several different programs and services multiplexed into a single transport stream.

The digital transport stream is output by the tuner 120, said tuner 120 including a demodulator (not shown). Then the digital transport stream is passed through a demultiplexer 130 (step 503). Demultiplexer 130 typically acquires the PID of the service that is to be displayed and extracts the transport stream packets relevant to the service that is to be displayed. Alternatively, the transport stream packets received by the demultiplexer 130 may be encrypted. In such a case, the demultiplexer acquires the PID of the encrypted service that is to be displayed and extracts the encrypted transport stream packets and associated Entitlement Control Message (ECM) relevant to the encrypted service that is to be displayed.

Client device 100 further comprises a descrambler 150 that typically descrambles/decrypts encrypted transport stream packets. Descrambler 150 typically includes an ECM filter (not shown) which communicates the ECM associated to the service that is to be displayed to a Control Word (CW) manager 151. Then, the CW manager 151 derives a control word from the ECM for use in decrypting encrypted transport stream packets.

Client device 100 further comprises a decoder 160 that typically includes at least one audio decoder (not shown) and at least one video decoder (not shown). Decoder 160 typically receives and decodes audio and video frames as part of the transport stream packets relevant to the service that is to be played out and passes the decoded frames to display device 170 for display (step 504). In embodiments where the transport stream packets are encrypted, decoder 160 typically receives and decodes the decrypted audio and video frames received as part of the decrypted transport stream packets relevant to the decrypted service that is to be played out and passes the decoded frames to display device 170 for display (step 504).

Client device 100 comprises a storage device 140 that typically includes a hard disk and/or high capacity memory and/or a buffer (e.g. traditional buffer, cyclic buffer, ring buffer, circular buffer, Random-Access Memory (RAM) or Double Data Rate (DDR) interfaced memory). It will be appreciated by those skilled in the art that the invention is not limited to the use of a single storage device and that multiple storage devices can be used. Furthermore, it will also be appreciated that the memory can either be volatile or non-volatile. In parallel to the demultiplexing, decoding, decrypting/descrambling and displaying processes for the service that is to be displayed, the transport stream packets corresponding to non-viewed services (also referred to as services not currently being displayed) are stored in the storage device 140 for later access, processing and display (step 504′). In embodiments where the transport stream packets are encrypted, the transport stream packets corresponding to encrypted non-viewed services are stored along with their associated ECMs in the storage device 140. An advantage of embodiments of the present invention is that there is no need to decrypt/descramble encrypted transport stream packets for encrypted non-viewed services while storing.

Client device 100 comprises a receiver (not shown) that typically includes an InfraRed (IR) receiver or a Bluetooth receiver or a wireless communication protocol receiver. Receiver typically receives a request to display a different service from the one currently displayed on the display device 170 from a remote source (e.g. a user) via a remote control apparatus.

Upon reception of a request from a user to display a different service (step 505) from the one currently displayed on the display device 170, client device 100 stops playing out the current service and the transport stream packets (or the encrypted transport stream packets with their associated ECMs) are sent directly to the demultiplexer 130 from the storage device 140. The demultiplexer 130 identifies and extracts the transport streams packets (or the encrypted transport stream packets and associated ECMs) relevant to the different service that is now to be displayed (step 506). Then, the descrambler 150 decrypts/descrambles, if necessary, the transport stream packets relevant to the different service as described previously. Hence, the client device 100 retrieves ECMs and Program Specific Information (PSI) such as Program Association Table (PAT), or Program Mapping Table (PMT), etc. from the transport stream packets stored in the storage device 140 without waiting for the arrival of additional data from the headend. This reduces the service change time by eliminating the data acquisition time and reducing the decrypting time.

In an embodiment of the present invention, the encrypted transport stream packets may be decrypted prior to storing them in the storage device. Hence, the service change time may be reduced by eliminating the decrypting time.

The transport stream packets (or decrypted transport stream packets) of the requested different service are then sent to the decoder 160. Decoder 160 plays and decodes the elementary stream packets corresponding to the relevant audio and video streams extracted from the transport stream packets sent from the storage device 140 at speeds faster than real-time (step 507). Concurrently, the transport stream packets (or the encrypted transport stream packets with associated ECMs) of the requested different service that are received after reception of the user's request are stored in the storage device 140 (step 507′). Upon completion of playing and decoding the elementary stream packets extracted from the transport stream packets at speeds faster than real-time, client device 100 demultiplexes, decrypts/descrambles (if necessary) and decodes at real-time speed the transport stream packets of the requested different service stored after reception of the user's request (step 508). Client device 100 sends the decoded audio and video streams of the requested different service to the display device 170 (step 509). A faster service change may therefore be achieved according to embodiments of the present invention.

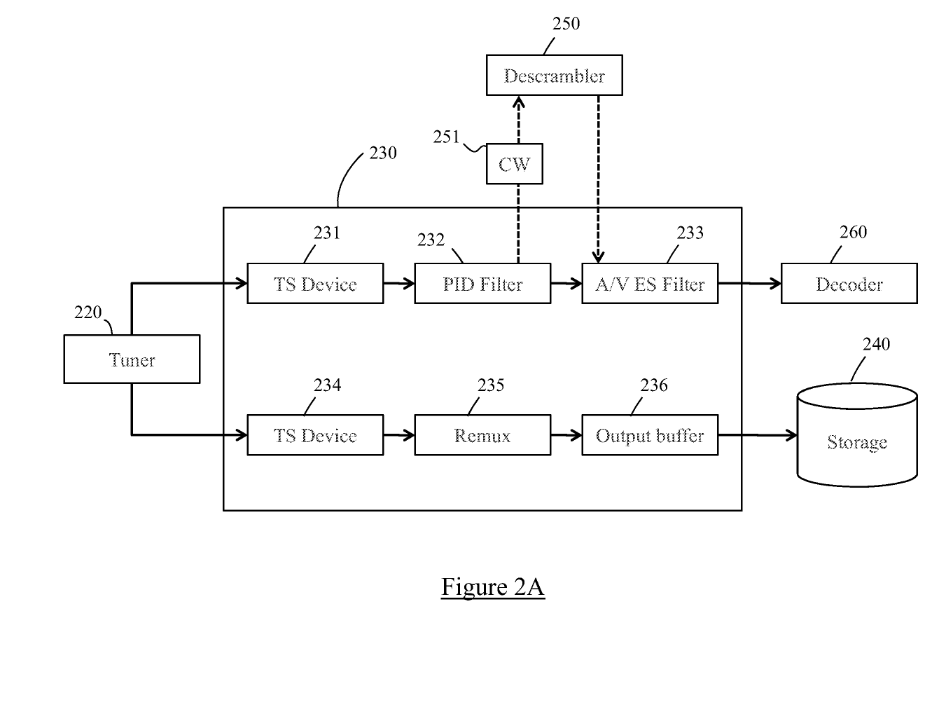

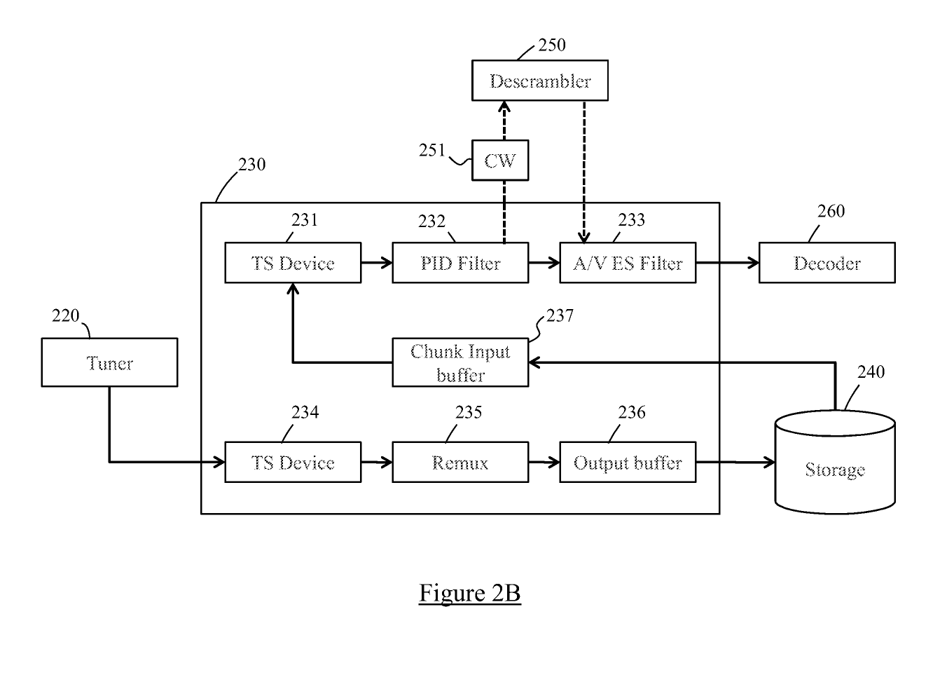

Reference is now made to FIGS. 2A and 2B, which are simplified block diagram illustrations of a demultiplexer constructed and operative in accordance with further embodiment of the present invention.

Demultiplexer 230 comprises Transport Stream devices (TS device) 231 and 234, a remultiplexer 235 (remux), an output buffer 236, a chunk input buffer 237, a PID filter 232 and an Audio/Video Elementary Stream filter (AV ES Filter) 233.

As described previously in relation to FIG. 1, demultiplexer 230 receives a transport stream output from the tuner 220 in FIG. 2A. Demultiplexer 230 extracts the transport stream packets (or the encrypted transport stream packets with their associated ECMs) relevant to the service that is to be displayed and passes them to the decoder (not shown in FIG. 2A-2B). To do so, a first TS device 231 processes the transport stream received from the tuner 220 and passes it through a PID filter 232 which identifies the transport stream packets having the same PID. Then, the A/V ES Filter 233 extracts the elementary stream packets corresponding to the relevant audio and video frames from the transport stream packets. In a case where the transport stream packets are encrypted, the PID filter 232 identifies and sends the encrypted transport stream packets with their associated ECMs to the descrambler 250. Then, the A/V ES Filter 233 extracts the elementary stream packets corresponding to the relevant audio and video frames from the decrypted transport stream packets. Finally, these audio and video streams are sent to the decoder 260.

In parallel to this demultiplexing operation, a second TS device 234 receives the transport stream from the tuner 220. The TS device 234 processes the transport stream and sends it to the remultiplexer 235. The remultiplexer 235 produces a partial transport stream comprising transport stream packets (or encrypted transport stream packets with their associated ECMs) of non-viewed services from the initial transport stream received from the tuner 220. This partial transport stream is sent to an output buffer 236 and then copied to the storage device 240.

Upon reception of a request from a user to display a different service, client device stops playing out the current service and the transport stream packets (or the encrypted transport stream packets with their associated ECMs) are sent directly to the demultiplexer 230 from the storage device 240 as shown in FIG. 2B. In other words, the first TS device 231 stops receiving the transport stream from the tuner 220 and takes the partial transport stream stored in the storage device 240 as input. An intermediate step of this operation consists of sending the partial transport stream from the storage device 240 to a chunk input buffer 237 and then to the TS device 231. Then, the TS device 231 processes the partial transport stream and the PID and A/V ES filters extracts the relevant elementary stream packets relevant to audio and video streams from the transport stream packets (or from the decrypted transport stream packets) for further decoding and playing out. It will be appreciated by those skilled in the art that additional intermediate buffers may be integrated in the demultiplexer 230 depending on the software implementation and that if the storage device 240 itself is a buffer, then the output and chunk input buffers can be removed.

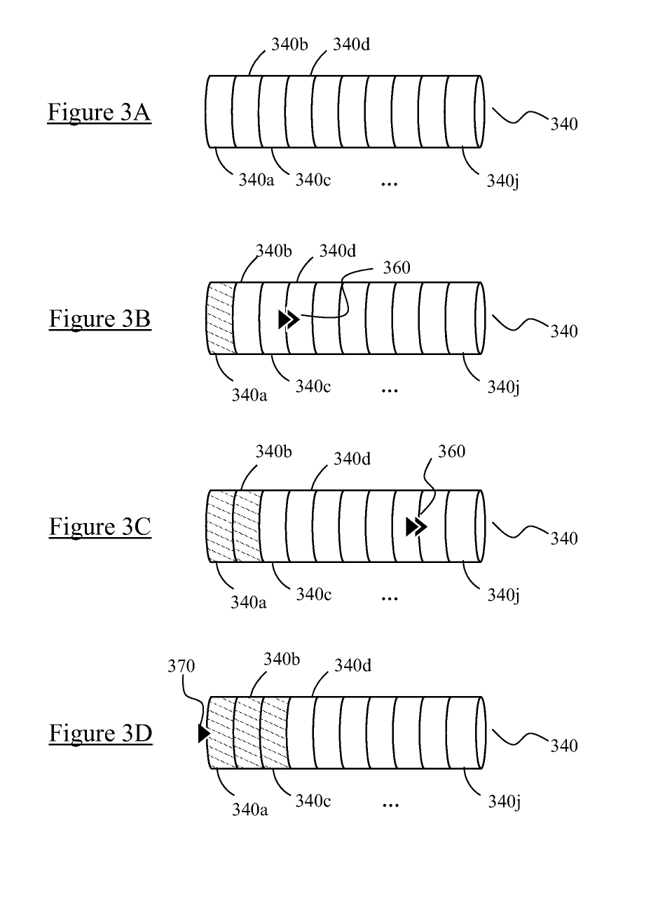

Reference is now made to FIG. 3A-3D, which are simplified illustrations of a storage device constructed and operative in accordance with embodiments of the present invention.

FIG. 3A shows a storage device 340 that typically comprises an array of memory areas 340a, 340b, 340c, 340d, . . . , 340j, wherein each memory area contains transport stream packets (or encrypted transport stream packets and associated ECMs) received for a predetermined amount of time. For simplicity of description and depiction, and without limiting the generality of the invention, ten memory areas have been drawn in FIG. 3A-3D. It will be remembered that in parallel to steps 503 and 504, consisting of successive operations to display the service chosen by the user, the storage device 340 receives the transport stream packets (or the encrypted transport stream packets and associated ECMs) of non-viewed services in step 504′ and starts filling memory area 340a. It will be appreciated by those skilled in the art that ECMs associated with the encrypted transport stream packets may also be stored separately in another file (e.g. a metadata file). Once memory area 340a filled, the subsequent transport stream packets (or the encrypted transport stream packets and associated ECMs) are stored in memory area 340b. When all memory areas are filled, storage device 340 stores the newly received transport stream packets (or the newly received encrypted transport stream packets and associated ECMs) by overwriting the oldest transport stream packets (or the oldest encrypted transport stream packets and associated ECMs) stored in the storage device 340 (i.e. those stored in memory area 340a).

In an embodiment of the present invention, the most recent transport stream packets (or the most recent encrypted transport stream packets and associated ECMs) of non-viewed services may be stored in the storage device 340.

In an alternative embodiment, the most recent transport stream packets (or the most recent encrypted transport stream packets and associated ECMs) of non-viewed services may be stored in the storage device 340 and the storage device 340 is configured so that an I-frame is stored for later access at any time. In other words, the transport stream packets (or the encrypted transport stream packets and associated ECMs) received during at least a GOP duration are stored in the storage device 340 at any time. Those skilled in the art will appreciate that the transport stream packets (or the encrypted transport stream packets and associated ECMs) received during at least a GOP duration can contain a single entire GOP or more frequently two incomplete GOPs. Typically, the transport stream packets (or the encrypted transport stream packets and associated ECMs) received during the last 0.5 seconds are stored in the storage device 340. It is to be noted that a typical GOP duration is approximately 0.5 seconds.

In another embodiment, the transport stream packets (or the encrypted transport stream packets and associated ECMs) received for the previous 0.8 seconds are stored in the storage device 340 to account for a typical GOP duration of approximately 0.5 seconds and a synchronization time of approximately 0.25 seconds.

The operation of the storage device will be described below in relation to FIG. 3A-3D.

FIG. 3A-3D show a storage device 340 structure comprising memory areas 340a, 340b, 340c, 340d, . . . , 340j. The transport stream packets (or the encrypted transport stream packets and associated ECMs) stored in the storage device 340 are circularly updated (i.e. the newly received transport stream packets (or the newly received encrypted transport stream packets and associated ECMs) are stored by overwriting the oldest transport stream packets (or the oldest encrypted transport stream packets and associated ECMs) as described previously in relation to FIG. 3A) and the storage device 340 is configured so that at least an I-frame is stored.

In an embodiment of the invention, after reception of a user's request for displaying a different service (step 505) and identification of the requested service that is now to be displayed (step 506), the content of the storage device 340 (i.e. transport stream packets (or encrypted transport stream packets and associated ECMs) of non-viewed services) is played out at speeds faster than real time. In general, DVRs and players such as digital video disc (DVD) players and BluRay players allow users to move through recorded or stored video content as they desire. For example, the user will be able to playback the video content in either forward or reverse directions at speeds slower or faster than a normal playback speed, wherein normal playback speed being designated 1× by convention. Such playback features are also known as trick modes. It is to be noted that various fast forward/fast backward speeds can be implemented such as for example 2×, 4×, 8×, 16×, etc. The black double arrow 360, in FIGS. 3B and 3C, illustrates that the content of the storage device 340 is played in fast forward trick mode. Upon reception of the stored content, the decoder may perform decoding at speeds faster than real-time.

In a further embodiment of the present invention, playing out the stored content at speeds faster than real-time is achieved by playing the content in fast forward trick mode 360.

In another embodiment, playing out the stored content at speeds faster than real-time is achieved by playing the content in maximum fast forward trick mode speed 360. Additionally, some or all B-frames or equivalent frames may be skipped to accelerate the trick mode speed.

In a further embodiment, the stored content is played in fast forward system time clock (STC) trick mode 360. STC trick mode consists of selecting a trick mode rate and adjusting a STC update rate as a function of the selected trick mode rate. The advantage of using STC trick mode is that synchronization between audio and video is maintained. Hence, any synchronization delay induced by the difference between the decode order and the display order may be eliminated.

In a further embodiment of the invention, the stored content is played in fast forward trick mode speed 360, but said fast forward trick mode speed is not constant. As described above, playing the stored content in STC trick mode speed has the advantage of maintaining the audio and video synchronization. Nevertheless, in some cases, the decoder 160 fails to achieve the synchronization at high speeds. Therefore, the STC trick mode speed may be reduced to ensure that the decoder 160 will be able to perform the audio and video synchronization. Similarly, if the decoder 160 is able to maintain the audio and video synchronization at higher speeds, the STC trick mode speed may be increased.

In a further embodiment, only a portion of the stored content is played at speeds faster than real time 360. Referring once again to FIG. 3A, at any time, the storage device 340 contains a portion of content corresponding to the content stored before receiving the request for service change. Upon reception of a request for displaying a different service, this portion of content is played out in fast forward trick mode. During the fast forward trick mode operation 360, a subsequent portion of content (illustrated by hatching) is stored in the storage device as shown in FIGS. 3B and 3C (since it will be remembered that the storage device is circularly updated). Upon completion of the fast forward trick mode operation 360, the subsequent portion, illustrated by hatched memory areas 340a, 340b and 340c in FIG. 3D, can be played at real-time speed 370. Then the decoding and displaying processes are performed accordingly at real-time speed. Another advantage of the present invention is that the first frame to be displayed on the display device can be any type of frame (I-, B- or P-frame). Typically, this corresponds to the first frame of the subsequent portion.

The different service displayed on the display device using the buffering techniques may lag behind the actual broadcast. Those skilled in the art will appreciate that the time between the last stored I-frame and the first frame of the live broadcast represents a lag time between the displayed frame from the stored content and the current broadcast frame. Nevertheless, in embodiments of the present invention this lag is a function of the transport stream packets stored in the storage device 340 and the speed at which the trick mode operation is performed on the portion of the content stored upon reception of the user's request for displaying a different service. Therefore, embodiments of the present invention provide an unique solution to reduce this lag by playing the content stored upon reception of the user's request for displaying a different service at speeds faster than real-time. It will be appreciated by those skilled in the art that well-known techniques may be implemented to eventually catch-up with the live broadcast. Typically, the decoder 160 can increase slightly the decoding speed of the stored subsequent portion or skip some frames from decoding to catch-up later with the live broadcast.

In another embodiment of the present invention, the lag can be reduced so that it will be almost unnoticeable to the user. This is achieved by performing the fast forward STC trick mode operation on both portions. In other words, the content stored before and during the trick mode operation is played in fast forward STC trick mode speed. This operation can be repeated several times on the content stored during the trick mode operations.

By continuously storing the most recent transport stream packets (i.e. the most recent I-frames) (or the most recent encrypted transport stream packets and associated ECMs) of non-viewed services and playing out these transport streams packets at speeds faster than real-time, client device 100 no longer needs to wait as long as the GOP duration plus the synchronization time before starting the decoding and the displaying processes. Accordingly, the service change time may be reduced.

In a further embodiment of the present invention, the audio and video presentation can be stopped before playing out the stored content at speeds faster than real-time from storage device 140. Therefore, no video frames are displayed on the display device 170 during the service change, which improves the user viewing experience. Rather, a black screen can be displayed on the display device 170 preventing the user from viewing the content of the circular buffer when it is played at speeds faster than real-time. Alternatively, those skilled in the art will appreciate that all frames, some frames, a single frame such as an I-frame or a still image may be displayed on the display device 170 during the service change before displaying the first frame of the subsequent portion.

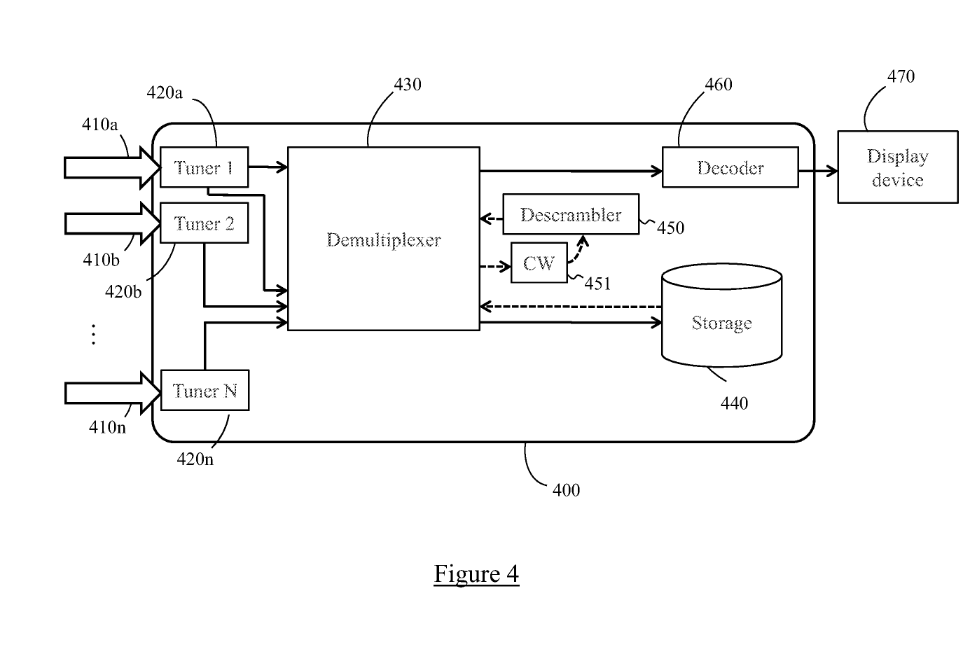

Reference is now made to FIG. 4, which is a simplified block diagram illustration of a system constructed and operative in accordance with an embodiment of the present invention.

In an embodiment of the present invention, client device 400 may comprise two or more tuners 420a, 420b, . . . , 420n. Client device 400 takes advantage of having multiple front-end tuners to acquire multiple transport streams 410a, 410b, . . . , 410n simultaneously. Therefore, client device 400 is able to tune to different frequency carriers, said frequency carriers transmitting different transport streams, and to acquire transport stream packets (or encrypted transport stream packets and associated ECMs) of services not currently being displayed on the display device 470.

Using multiple front-end tuners or a wideband front-end tuner which is able to tune on multiple transport streams has the advantage of increasing the number of transport streams packets (or the number of encrypted transport stream packets and associated ECMs) stored in the storage device 440, and therefore the number of services available for fast service change in response to a request for displaying a different service. This also permits a reduction in the service change delay by eliminating the tuning delay that results if the requested service for display is on another transport stream.

It will be appreciated by those skilled in the art that, even with a high capacity storage device 440, it will be difficult to store all services received from the headend. In an embodiment of the present invention, client device 400 is able to tune into a transport stream and store the transport stream packets corresponding to all the services carried on said transport stream. In another embodiment, client device 400 further runs a prediction algorithm to select which services are to be stored in the storage device 440. The prediction algorithm applies different criteria or rules in order to select the transport stream packets (or the encrypted transport stream packets and associated ECMs) to store in the storage device 440. For example, and without limiting the generality of the invention, the prediction algorithm may determine that adjacent services (i.e. services listed in the Electronic Program Guide (EPG) by a television operator immediately before and after the one currently being displayed and/or the n services listed in the Electronic Program Guide (EPG) by a television operator before and after the one currently being displayed) and/or user's favorite services (i.e. a list of services marked by the user as favorite services in an EPG) and/or most frequently watched services and/or last watched services and/or services matching the user's profile or interest and/or services in which said user has made the most recordings and/or services browsed in an Electronic Program Guide and/or services listed by a television operator etc. can be stored in the storage device 440 at any time. In an embodiment of the present invention, the user is typically able to set reminders, using the electronic program guide for example, for an event that is to be broadcast in the future by ‘tagging’ that event. Typically, a notification is then sent to the user when the tagged event is about to be broadcast. A user can also ‘tag’ an event by scheduling that event for recording. When a user tags an event, the user can also have been said to have ‘tagged’ the service on which that event is broadcast. In further embodiments of the present invention, the prediction algorithm may determine that services that will broadcast tagged events, and/or services about to broadcast a tagged event, and/or services broadcasting events most frequently tagged by the user can be stored in the storage device 440 at any time. The prediction algorithm can additionally use Digital Video Broadcasting sections such as Event Information Tables present and following (EITpf), EIT scheduled (EITsch), PAT or PMT for selecting which services are to be stored in the storage device 440. It will be appreciated by those skilled in the art that the predictor algorithm can be implemented as software logic to select which services are to be stored in the storage device 440.

In another embodiment, the predictor algorithm can set a maximum number m of services that are to be stored, where m can vary from 1 to 20 depending on the capacity of the storage device 440. Typically, client device 400 includes three tuners and the number of services stored depends on the prediction algorithm used.

In a further embodiment of the present invention, the most recent transport stream packets (or the most recent encrypted transport stream packets and associated ECMs) of all predicted services may be stored in the storage device 340, so that the most recent I-frames will be available for later access.

It will be remembered that the accumulation of all the times involved in a service change leads to an overall time of at least approximately 1 second for non-encrypted services, and often of at least approximately 1.4 seconds for encrypted services.

For encrypted services, the service change time (Tsc) is given by:

Tsc=Tuning time+Acquiring time+Decrypting time+MPEG Sequencing time

It will also be remembered that the decrypting time and the MPEG Sequencing time are given by:

Decrypting time=ECM Acquiring time+CW Generating time MPEG Sequencing time=I frame time+Sync.time

For non-encrypted services, the service change time (Tsc) is given by:

Tsc=Tuning time+Acquiring time+MPEG Sequencing time

Embodiments of the present invention take advantage of having a storage device for identifying and storing transport stream packets (or encrypted transport stream packets and associated ECMs) for non-viewed services, prior to receiving a request for service change from a user. Hence, the service change time (Tsc) may be reduced since the tuning time, the data acquiring time and the ECM acquiring time have been eliminated.

For encrypted services, the service change time (Tsc) of embodiments of the present invention is therefore given by: Tsc=CW Generating time+I frame time+Sync.time

For non-encrypted services, the service change time (Tsc) of embodiments of the present invention is therefore given by:

Tsc=I frame time+Sync.time

Furthermore, as noted above, by continuously storing the most recent transport stream packets (i.e. the most recent I-frames) (or the most recent encrypted transport stream packets and associated ECMs) of non-viewed services and playing these transport streams packets at speeds faster than real-time, client device 100 no longer needs to wait as long as the I-frame time plus the synchronization time before starting the decoding and the displaying processes. It will be appreciated by those skilled in the art that the time it takes to get an I-frame (I-frame time) depends on the transport stream packets stored in the storage device and the STC trick mode speed.

In an embodiment of the present invention, the transport stream packets (or the encrypted transport stream packets with their associated ECMs) received during the last GOP duration plus the synchronization time are stored in the storage device (typically, the transport stream packets (or the encrypted transport stream packets and their associated ECMs) received for the last 0.8 seconds). Therefore, the MPEG Sequencing time may be reduced and is given by:

$$MPEG Sequencing time = \frac{Stored packet duration}{STC trick mode speed}$$

For the sake of clarity, and without limiting the generality of the invention, the following example will aid understanding the above equation:
If the storage device contains the transport stream packets (or the encrypted transport stream packets and their associated ECMs) received for the last 1 second; and
If a STC trick mode speed of 4x is chosen for playing the content of the storage device at speeds faster than real-time;
Then, the MPEG Sequencing time will be 0.25 seconds.

Consequently, the service change time (Tsc) for encrypted service is given by:

$$Tsc = CW Generating time + \frac{Stored packet duration}{STC trick mode speed}$$

For non-encrypted services, the service change time (Tsc) is given by:

$$Tsc = \frac{Stored pa cket duration}{STC trick mode speed}$$

In a further embodiment of the present invention, the stored packet duration can be less than the GOP duration (0.25 seconds for example). However, it is still possible that an I-frame is stored in the storage device. In the worst case, the I-frame will be stored at the end of the storage device so that the content of the storage device will be played at speeds faster than real time but the A/V synchronization will not be achieved. In this embodiment of the present invention, the MPEG Sequencing time is still reduced and is given by:

$$MPEG Sequencing time = \frac{Stored packet duration}{STC trick mode speed} + Sync . time$$

Consequently, the service change time (Tsc) for encrypted services is given by:

$$Tsc = CW Generating time + \frac{Stored packet duration}{STC trick mode speed} + Sync . time$$

For non-encrypted services, the service change time (Tsc) is given by:

$$Tsc = \frac{Stored pa cket duration}{STC trick mode speed} + Sync . time$$

On the other hand, it is also possible that no I-frame is stored in the storage device. As described above, the content of the storage device will be played at speeds faster than real time but it will not be possible to perform the decoding operation since no I-frame will have been received. Therefore, the MPEG Sequencing time will increase by an amount corresponding to the time it takes to receive the I-frame. In the worst case, this time can be as much as the remaining GOP duration. Furthermore, the A/V synchronization will not be achieved. Therefore, the MPEG Sequencing time is still reduced and is given by:

$$MPEG Sequencing time = \frac{Stored packet duration}{STC trick mode speed} + Remaining GOP time + Sync . time$$

Consequently, the service change time (Tsc) for encrypted service is given by:

$$Tsc = CW Generating time + \frac{Stored packet duration}{STC trick mode speed} + Remaining GOP time + Sync . time$$

For non-encrypted services, the service change time (Tsc) is given by:

$$Tsc = \frac{Stored pa cket duration}{STC trick mode speed} + Remaining GOP time + Sync . time$$

The Table below shows the calculations made for different stored packet durations and for a STC trick mode speed of 8×.

TABLE 3
Worst case service change time for STC trick mode speed 8×

| | Non-encrypted | Encrypted |
|---|---|---|
| | Services (Tsc in ms) | Services (Tsc in ms) |
| Current time | 1000 | 1400 |
| Stored packet duration = | 100 | 400 |
| 800 ms | | |
| Stored packet duration = | 281 | 581 |
| 250 ms & I-frame stored | | |
| Stored packet duration = | 531 | 831 |
| 250 ms & no I-frame stored | | |

It will be appreciated by those skilled in the art that the service change times can be reduced further by playing the content of the storage device at higher STC trick mode speeds such as 16×, 32×, 64× etc.

It is clear from Table 3 that embodiments of the present invention are advantageous over prior art systems in use.

Although the above embodiments have been described in the context of DVB implementation, someone skilled in the art will realize that other implementations are possible.

Although the above embodiments have been described as being carried out on the receiving device side, someone skilled in the art will appreciate that various features of the invention may be implemented in intermediate network components and/or on the headend side prior to sending the relevant transport stream packets to the receiving device.

It is appreciated that various features of the invention which are, for clarity, described in the contexts of separate embodiments may also be provided in combination in a single embodiment. Conversely, various features of the invention which are, for brevity, described in the context of a single embodiment may also be provided separately or in any suitable subcombination.

It will be appreciated by persons skilled in the art that the present invention is not limited to what has been particularly shown and described hereinabove. Rather the scope of the invention is defined by the appended claims and equivalents thereof.

1. A method comprising:
receiving a plurality of transport streams at a client device, each transport stream including a plurality of encrypted services;
decrypting an encrypted service from said plurality of encrypted services thereby forming a decrypted service;
playing out said decrypted service on said client device;
storing a portion of at least one encrypted service with its associated entitlement control messages ECMs from said plurality of encrypted services in a storage device located on said client device;
receiving a request for displaying a different encrypted service on said client device;
identifying a stored portion of said different encrypted service;
decrypting said stored portion of said different encrypted service using said associated ECMs thereby forming a decrypted stored portion;
playing out said decrypted stored portion of said different encrypted service on said client device at a faster than real time speed;
storing a subsequent portion of said different encrypted service with ECMs associated with said subsequent portion in said storage device located on said client device, said subsequent portion corresponding to a subsequent portion of said different encrypted service received during said decrypting said stored portion and said playing out said decrypted stored portion of said different encrypted service;
decrypting said subsequent portion of said different encrypted service using said ECMs associated with said subsequent portion thereby forming a decrypted subsequent portion; and
playing out said decrypted subsequent portion of said different encrypted service for display upon completion of said playing out said decrypted stored portion.

2. A method according to claim 1, wherein said playing out said decrypted stored portion of said different encrypted service comprises playing out said decrypted stored portion of said different encrypted service in System Time Clock fast forward speed.

3. A method according to claim 1, wherein said playing out said decrypted stored portion of said different encrypted service comprises playing out said decrypted stored portion of said different encrypted service at a maximum faster than real time speed that the client device is able to handle.

4. A method according to claim 1, wherein said playing out said decrypted stored portion of said different encrypted service comprises playing out said decrypted stored portion of said different encrypted service at a non-constant speed.

5. A method according to claim 1, wherein said playing out of said decrypted subsequent portion commences with a P-frame.

6. A method according to claim 1, wherein said playing out of said decrypted subsequent portion commences with a B-frame.

7. A method according to claim 1, further comprising updating the storage device to store transport stream packets of at least one encrypted service most recently received.

8. A method according to claim 1, wherein said portion of at least one encrypted service comprises transport stream packets received during a time taken to receive a group of pictures.

9. A method according to claim 8, wherein said portion of at least one encrypted service further comprises transport stream packets received during a time taken to achieve audio and video synchronization.

10. A method according to claim 1, wherein said stored portion of at least one encrypted service further comprises transport stream packets received during a time taken to receive less than a group of pictures.

11. A method according to claim 10, wherein said stored portion comprises an I-frame.

12. A method according to claim 10, wherein said stored portion does not comprise an I-frame.

13. A method according to claim 1, said method further comprising:
selecting said at least one encrypted service from said plurality of encrypted services.

14. A method according to claim 13, wherein said selecting at least one encrypted service from said plurality of encrypted services comprises selecting one or more of the following:
at least one user favorite encrypted service;
encrypted services adjacent to said decrypted service;
encrypted services more frequently watched;
encrypted services most recently browsed in an electronic program guide;
encrypted services listed by a television operator;
encrypted services matching a user profile;
encrypted services most frequently recorded;
at least one encrypted service broadcasting events tagged by the user;
encrypted services broadcasting events most frequently tagged by the user;
encrypted services about to broadcast a tagged event; and
all encrypted services on at least one of said plurality of transport streams.

15-25. (canceled)

26. A receiving device comprising:
means for receiving a plurality of transport streams, each transport stream including a plurality of encrypted services;
means for decrypting an encrypted service from said plurality of encrypted services to form a decrypted service;
means for playing out said decrypted service;
means for storing a portion of at least one encrypted service with its associated entitlement control messages [ECMs] from said plurality of encrypted services;
means for receiving a request for displaying a different encrypted service;
means for identifying a stored portion of said different encrypted service;
wherein said means for decrypting is further for decrypting said stored portion of said different encrypted service using said associated ECMs to form a decrypted stored portion; and said means for playing out is further for playing out said decrypted stored portion of said different encrypted service at a faster than real time speed; and said means for storing is further for storing a subsequent portion with ECMs associated with said subsequent portion of said different encrypted service, said subsequent portion corresponding to a subsequent portion of said different encrypted service received during said decrypting said stored portion and said playing out said decrypted stored portion of said different encrypted service; and said means for decrypting is further for decrypting said stored subsequent portion of said different encrypted service using said ECMs associated with said subsequent portion to form a decrypted subsequent portion; and said means for playing out is further for playing out said decrypted subsequent portion of said different encrypted service for display upon completion of said playing out of said decrypted stored portion.

27. A receiving device comprising:
at least one tuner operable to receive a plurality of transport streams, each transport stream including a plurality of encrypted services;
a descrambler operable to decrypt an encrypted service from said plurality of encrypted services to form a decrypted service;
a play out system operable to play out said decrypted service;
a receiver operable to receive a request for displaying a different encrypted service;
a storage device operable to store a portion of at least one encrypted service with its associated entitlement control messages [ECMs] from said plurality of encrypted services;
a demultiplexer operable to identify a stored portion of said different encrypted service;
wherein said descrambler is further operable to decrypt said stored portion of said different encrypted service using said associated ECMs to form a decrypted stored portion; and said play out system is further operable to play out said decrypted stored portion of said different encrypted service at a faster than real time speed; and said storage device is further operable to store a subsequent portion with ECMs associated with said subsequent portion of said different encrypted service, said subsequent portion corresponding to a subsequent portion of said different encrypted service received during said decrypting said stored portion and said playing out said decrypted portion of said different encrypted service; and said descrambler is further operable to decrypt said stored subsequent portion of said different encrypted service using said ECMs associated with said subsequent portion to form a decrypted subsequent portion; and said play out system is further operable to play out said decrypted subsequent portion of said different encrypted service for display upon completion of said playing out of said decrypted stored portion.
